(19) United States
(12) Patent Application Publication
(10) Pub. No.: US 2020/0195945 A1
(43) Pub. Date: Jun. 18, 2020

(54) IMAGE PROCESSING APPARATUS

(71) Applicant: DENSO CORPORATION, Kariya-city (JP)

(72) Inventor: Haruhiko SOGABE, Kariya-city (JP)

(21) Appl. No.: 16/800,851

(22) Filed: Feb. 25, 2020

Related U.S. Application Data
(63) Continuation of application No. PCT/JP2018/028788, filed on Aug. 1, 2018.

(30) Foreign Application Priority Data
Sep. 14, 2017 (JP) 2017-177019

(51) Int. Cl. H04N 19/42; H04N 19/39; H04N 7/18; H04N 21/2743

(52) U.S. Cl. CPC H04N 19/42; H04N 21/2743; H04N 7/188; H04N 19/39

(57) ABSTRACT

An image processing apparatus includes: a hardware encoder that compresses captured images using a dedicated circuit; multiple software encoders that compress the captured images on a general-purpose processor, wherein each of the software encoders compresses the captured images having different total number of pixels and each having a smaller total number of pixels than a total number of pixels employed by the hardware encoder; a non-volatile memory that sequentially stores the captured images compressed by the hardware encoder; and a transmission portion that transmits, using wireless communication, the captured images compressed by the software encoders to a receiver device.

### CROSS REFERENCE OF RELATED APPLICATION

The present application is a continuation application of International Patent Application No. PCT/JP2018/028788 filed on Aug. 1, 2018 which designated the U. S. and claims the benefit of priority from Japanese Patent Application No. 2017-177019 filed on Sep. 14, 2017. The entire disclosures of all of the above applications are incorporated herein by reference.

### TECHNICAL FIELD

The present disclosure relates to an image processing apparatus which compresses a captured image.

### BACKGROUND

A technology for compressing a captured image has been known.

### SUMMARY

The present disclosure describes an image processing apparatus including: a hardware encoder compressing a captured image using a dedicated circuit; a software encoder compressing the captured image on a general-purpose processor; a non-volatile memory storing the captured image compressed by the hardware encoder; and a transmission portion transmitting the captured images compressed by the software encoders.

### BRIEF DESCRIPTION OF DRAWINGS

Objects, features, and advantages of the present disclosure will become more apparent from the following detailed description with reference to the accompanying drawings. In the drawings:

FIG. 1 is a diagram showing an example of a schematic configuration of a captured image transmission system;

FIG. 2 is a diagram showing an example of a schematic configuration of a vehicle unit;

FIG. 3 is a diagram showing an example of a schematic configuration of a communication terminal;

FIG. 4 is a diagram for explaining an example of image scale conversion by a conversion section;

FIG. 5 is a flowchart showing an example of a flow of an image accumulation associated process performed by the communication terminal;

FIG. 6 is a flowchart showing an example of a flow of an image transmission associated process performed by the communication terminal;

FIG. 7 is a diagram showing an example of a schematic configuration of a captured image transmission system;

FIG. 8 is a diagram showing an example of a schematic configuration of a communication terminal;

FIG. 9 is a flowchart showing an example of a flow of a request image transmission associated process performed by the communication terminal;

FIG. 10 is a diagram showing an example of a schematic configuration of a captured image transmission system; and

FIG. 11 is a diagram showing an example of a schematic configuration of a communication terminal.

### DETAILED DESCRIPTION

A drive recorder which compresses and stores a captured image has been known. For example, a related art discloses a hardware encoder which uses a dedicated chip. The chip stores an algorithm achieving high-efficiency and high-quality data compression.

There may be a demand for accumulating and transmitting a captured image, such as a monitoring image, and a traveling image recorded by a drive recorder. A hardware encoder, which uses the dedicated chip as disclosed in a related art and is capable of compressing data with high efficiency and high quality, may achieve accumulation of high-quality images. However, communication costs may rise when high-quality captured images compressed by the hardware encoder are sequentially transmitted. The communication costs may be reduced by lowering the quality of the captured images during transmission. However, the image quality may be difficult to lower by the hardware encoder which includes the dedicated chip.

The present disclosure describes an image processing apparatus capable of more easily reducing communication costs during transmission of a captured image while achieving accumulation of high-quality captured images.

According to one aspect of the present disclosure, an image processing apparatus compresses captured images sequentially captured by an imaging device, and the image processing apparatus may comprise: a hardware encoder that is configured to compress captured images using a dedicated circuit, the captured images being sequentially captured by the imaging device; a software encoder that is configured to compress the captured images on a general-purpose processor to have a smaller total number of pixels than a total number of pixels used by the hardware encoder, the captured images being sequentially captured by the imaging device; a non-volatile memory that is configured to sequentially store the captured images compressed by the hardware encoder; and a transmission portion that transmits, using wireless communication, the captured images compressed by the software encoder to a receiver device that is an external device of the image processing apparatus.

This configuration includes the hardware encoder that compresses the captured images sequentially captured by the imaging device using the dedicated circuit, and sequentially stores the captured images compressed by the hardware encoder in the non-volatile memory. Accordingly, accumulation of high-quality captured images is achievable using the hardware encoder. In addition, this configuration includes the software encoder that compresses, on the general-purpose processor, captured images sequentially captured by the imaging device and each having the smaller total number of pixels than the total number of pixels used by the hardware encoder, and transmits the captured images compressed by the software encoder to the receiver device using wireless communication. Accordingly, more reduction of communication costs is achievable than in a case of transmission of captured images compressed by the hardware encoder. The software encoder compresses the captured images on the general-purpose processor. This configuration is more easily produced than a configuration which additionally includes the one more hardware encoder for performing compression using a dedicated circuit. Furthermore, the configuration which uses both the hardware encoder and the software encoder can reduce shortage of processor resources. Accordingly, even while the general-purpose processor is used, accumulation of captured images captured by the imaging device, and transmission of captured images compressed while lowering the total number of pixels of the captured images captured by the imaging device are both more easily achievable. As a result, reduction of communication costs during transmission of captured images is more easily achievable while accumulating high-quality captured images.

Several embodiments for disclosure will be described with reference to the drawings. For convenience of description, the same reference numerals are assigned to portions having the same functions as those illustrated in the drawings used in the description so far among the multiple embodiments, and a description of the same portions may be omitted. The descriptions of other embodiments may be referred to with respect to these parts given the same reference numerals.

### First Embodiment

(Schematic Configuration of Captured Image Transmission System 1)

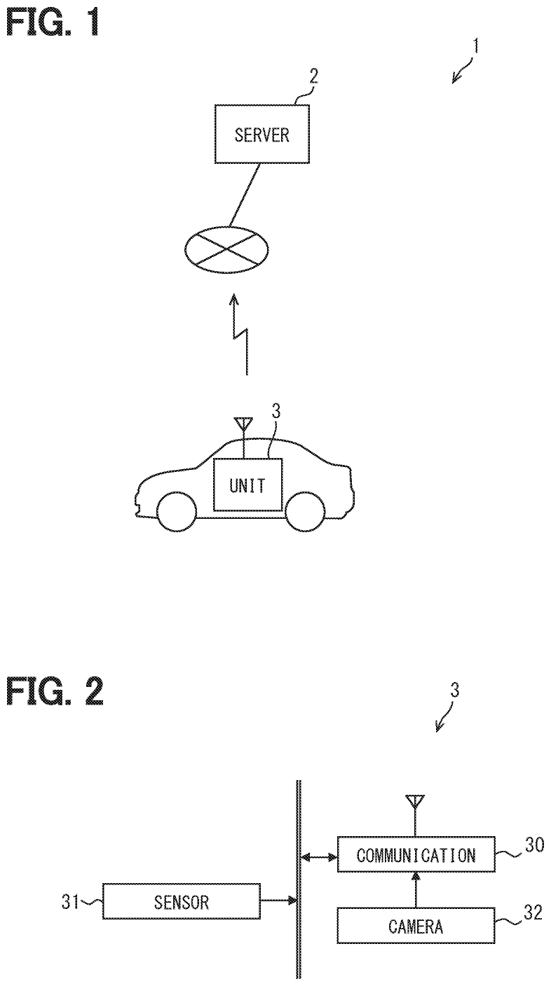

A first embodiment of the present disclosure will be hereinafter described with reference to the drawings. As shown in FIG. 1, a captured image transmission system 1 includes a server device 2, and a vehicle unit 3 provided on a vehicle.

The server device 2 collects captured images captured by a camera 32 of the vehicle, and transmitted from a communication terminal 30 described below and included in the vehicle unit 3 provided on the vehicle. The server device 2 may be constituted by either a single server device or multiple server devices. The server device 2 corresponds to a receiver device of the present disclosure.

The vehicle unit 3 is provided on the vehicle to sequentially capture images around the subject vehicle. The vehicle unit 3 also performs image compression (i.e., encoding) for compressing captured images sequentially captured. The captured images sequentially captured can be also referred to as moving images. The vehicle unit 3 accumulates compressed captured images, and communicates with the server device 2 by wireless communication to transmit the compressed captured images to the server device 2. Details of the vehicle unit 3 will be described below. The server device 2 is configured to receive compressed captured images transmitted from the vehicle unit 3, and perform decoding for expanding the compressed captured images.

(Schematic Configuration of Vehicle Unit 3)

An example of a schematic configuration of the vehicle unit 3 will be next described with reference to FIG. 2. As shown in FIG. 2, the vehicle unit 3 includes the communication terminal 30, a vehicle state sensor 31, and the camera 32. It is assumed that the communication terminal 30 and the vehicle state sensor 31 are connected to an in-vehicle local area network (LAN), for example. While FIG. 2 shows a configuration which directly connects the camera 32 to the communication terminal 30, this configuration is not necessarily required to be adopted. For example, a configuration which indirectly connects the camera 32 via the in-vehicle LAN may be adopted.

The vehicle state sensor 31 is a sensor group for detecting various states of the subject vehicle, such as a traveling state. Examples of the vehicle state sensor 31 include a vehicle speed sensor which detects a speed of the subject vehicle, a steering sensor which detects a steering angle of steering of the subject vehicle, and other sensors. The vehicle state sensor 31 outputs detected sensing information to the in-vehicle LAN. The sensing information detected by the vehicle state sensor 31 may be output to the in-vehicle LAN via an electric control unit (ECU) mounted on the subject vehicle.

The camera 32 is a camera provided on the subject vehicle to capture images in a predetermined range around the subject vehicle. The camera 32 corresponds to an imaging device of the present disclosure. The camera 32 may be either a camera mounted on the subject vehicle, or a camera of a smart phone, for example. The camera of the smart phone or the like used as the camera 32 may be connected to the communication terminal 30 described below via short range wireless communication, for example. Alternatively, the smart phone may function as both the camera 32 and the communication terminal 30 described below, and may be connected to the in-vehicle LAN via short range wireless communication, for example.

An imaging direction of the camera 32 may a direction toward the rear side of the subject vehicle, for example. However, according to the example described in the present embodiment, the imaging direction is a direction toward the front of the subject vehicle. In addition, according to the example described in the present embodiment, each of captured images sequentially captured by the camera 32 is a Full HD image with a resolution of 1920×1080 dots.

The communication terminal 30 communicates with the server device 2 via a public communication network. The communication terminal 30 compresses captured images sequentially captured by the camera 32, and sequentially stores the compressed captured images in an accumulation portion 303 described below. The communication terminal 30 also compresses images sequentially captured by the camera 32, and transmits the compressed captured images to the server device 2. Accordingly, the camera 32 and the communication terminal 30 perform a so-called drive recorder function. The communication terminal 30 corresponds to an image processing apparatus of the present disclosure. Details of the communication terminal 30 will be described below.

(Schematic Configuration of Communication Terminal 30)

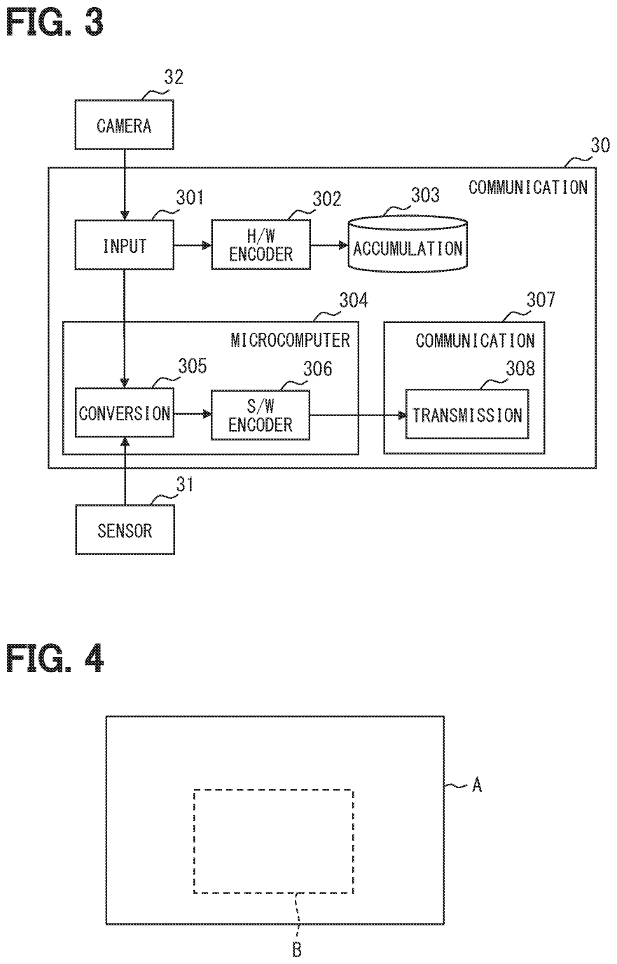

A schematic configuration of the communication terminal 30 will be next described. As shown in FIG. 3, the communication terminal 30 includes an input portion 301, a hardware encoder (hereinafter referred to as H/W encoder) 302, the accumulation portion 303, a microcomputer 304, and a communication portion 307.

The input portion 301 receives an input of captured images sequentially captured by the camera 32. The H/W encoder 302 is a device which compresses data using a dedicated circuit. The dedicated circuit referred to herein is a circuit specialized for image compression. It is assumed that the H/W encoder 302 achieves high-quality image compression by using an IC chip or the like on which this circuit is mounted. The H/W encoder 302 includes a circuit specialized for image compression as a dedicated circuit. The H/W encoder 302 compresses captured images sequentially acquired from the camera 32 via the input portion 301, and sequentially stores the compressed images in the accumulation portion 303. In the example of the present embodiment, full-high-definition (Full HD) captured images are compressed and sequentially stored in the accumulation portion 303.

The accumulation portion 303 is a non-volatile memory, and stores captured images compressed by the H/W encoder 302. The non-volatile memory may be a memory built in the communication terminal 30, or a removable memory card. Storage of the captured images compressed by the H/W encoder 302 in the accumulation portion 303 may start in response to a start of a traveling drive source of the subject vehicle, or at a predetermined event, such as detection of impact of the subject vehicle, with prohibition of overwriting. In the configuration which starts storage in response to the start of the traveling drive source of the subject vehicle, the captured images may be constantly stored, and sequentially deleted after an elapse of a predetermined time. In the configuration which starts storage at the time of the predetermined event with prohibition of overwriting, the captured images may be stored with prohibition of overwriting in a fixed time range of the captured images constantly stored before and after the predetermined event.

The microcomputer 304 includes a general-purpose processor, a memory, an I/O, and a bus for connecting these components, and executes a control program stored in the memory to execute various processes. The general-purpose processor referred to herein is a processor allowed to be incorporated in various built-in devices, and allowed to be also used for purposes other than image compression. The memory referred to herein is a non-transitory tangible storage medium which stores computer-readable programs and data in a non-temporary manner. The non-transitory tangible storage medium is implemented by a semiconductor memory or the like. As shown in FIG. 3, the microcomputer 304 includes a conversion section 305 and a software encoder (hereinafter referred to as S/W encoder) 306 as functional blocks.

The conversion section 305 performs conversion for lowering a total resolution of each of captured images sequentially acquired from the camera 32 via the input portion 301. More specifically, the conversion section 305 converts an image scale. For example, a Full HD captured image with a resolution of 1920×1080 dots is converted into a captured image of video graphics array (VGA) with a resolution of 640×480 dots. In an example described in the present embodiment, the conversion section 305 converts the image scale by cutting out a partial region of each of captured images sequentially acquired from the camera 32. In an example configuration, a captured image in a partial region in front of the subject vehicle (see B in FIG. 4) may be cut out from a captured image (see A in FIG. 4) captured by the camera 32 as shown in FIG. 4.

The region cut out by the conversion section 305 from the captured image captured by the camera 32 may be changed in accordance with the traveling state of the subject vehicle. The traveling state of the subject vehicle may be specified based on sensing information detected by the vehicle state sensor 31, for example. For example, during traveling of the subject vehicle, a partial region in front of the subject vehicle (see B in FIG. 4) may be cut out from the captured image captured by the camera 32. During a stop of the subject vehicle, a partial region including an area where a moving object is located may be cut out from the captured image captured by the camera 32. Whether the subject vehicle is traveling or stopping may be specified based on sensing information obtained by the vehicle speed sensor of the vehicle state sensors 31. The area where the moving object is located may be specified by identifying the moving object based on a vector of the object detected in common in a series of captured images by utilizing an image recognition technology, for example. The region cut out by the conversion section 305 may be a region divided into multiple sections.

In addition, the region to be cut out may be shifted in the same direction as a steering direction of the subject vehicle when the subject vehicle is steered by an amount equal to or more than a certain amount. The state of “steering by an amount equal to or more than a certain amount” herein may refer to steering by an amount equal to or more than a steering angle estimated to be a direction change, for example. Steering of the subject vehicle by an amount equal to or more than a certain amount, and the steering direction of the subject vehicle may be specified based on sensing information obtained by the steering angle sensor of the vehicle state sensor 31. In addition, the region to be cut out may be shifted in the same direction as the steering direction of the subject vehicle by an amount corresponding to the steering amount of the subject vehicle when the subject vehicle is steered by an amount equal to or more than a certain amount.

The S/W encoder 306 compresses captured images after conversion of the image scale by the conversion section 305. More specifically, the S/W encoder 306 compresses, on a general-purpose processor, the captured images sequentially captured by the camera 32 and having a smaller total number of pixels than a total number of pixels processed by the H/W encoder 302. When the configuration which changes the region cut out by the conversion section 305 in accordance with the traveling state of the subject vehicle is adopted, the S/W encoder 306 changes the region to be compressed in each of the captured images sequentially captured by the camera 32 in accordance with the traveling state of the subject vehicle.

The communication portion 307 includes a wireless communication antenna, and communicates with the server device 2 via a public communication network by mobile communication with a base station, or transmission and reception of information to and from an access point of a wireless LAN through wireless communication, for example. The communication portion 307 includes a transmission portion 308 as shown in FIG. 3. The transmission portion 308 transmits captured images compressed by the S/W encoder 306 to the server device 2 by using wireless communication. The transmission portion 308 may be configured to sequentially transmit the captured images sequentially compressed by the S/W encoder 306 to the server device 2, or may be configured to transmit the captured images to the server device 2 after a certain amount of the captured images are accumulated in the memory.

(Image Accumulation Associated Process by Communication Terminal 30)

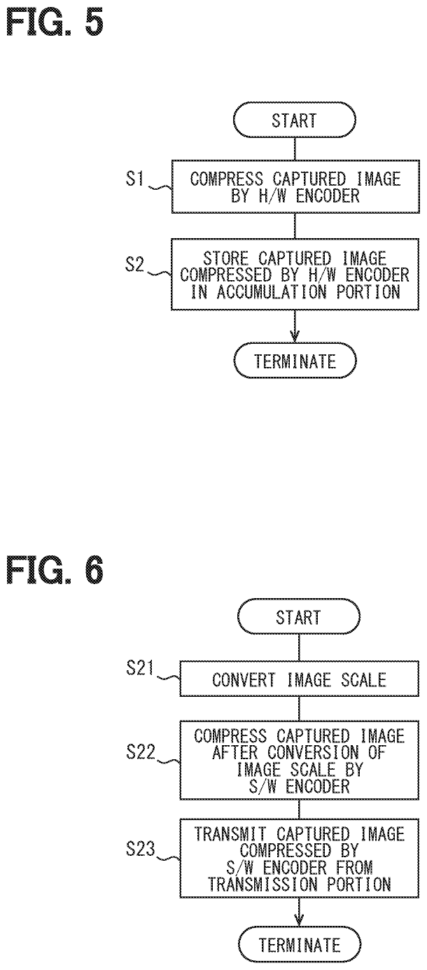

An example of a flow of a process associated with accumulation of captured images (hereinafter referred to as image accumulation associated process) performed by the communication terminal 30 will be herein described with reference to a flowchart of FIG. 5. The flowchart of FIG. 5 may be started when an input of captured images sequentially captured by the camera 32 is received by the input portion 301, for example.

In S1, the H/W encoder 302 initially compresses a captured image acquired from the camera 32 via the input portion 301. In S2, the H/W encoder 302 stores the captured image compressed in S1 in the accumulation portion 303, and terminates the image accumulation associated process.

(Image Transmission Associated Process by Communication Terminal 30)

An example of a flow of a process associated with transmission of a captured image (hereinafter referred to as image transmission associated process) performed by the communication terminal 30 will be next described with reference to a flowchart of FIG. 6. The flowchart of FIG. 6 may be started when an input of captured images sequentially captured by the camera 32 is received by the input portion 301, for example. An example of a case where the transmission portion 308 sequentially transmits captured images sequentially compressed by the S/W encoder 306 to the server device 2 will be described with reference to FIG. 6.

In S21, the conversion section 305 initially converts an image scale of a captured image acquired from the camera 32 via the input portion 301. In the example of the present embodiment, a Full HD captured image is converted into a VGA captured image.

In S22, the S/W encoder 306 compresses the captured image after conversion of the image scale in S21. In S23, the transmission portion 308 transmits the captured image compressed in S23 to the server device 2 using wireless communication, and terminates the image transmission associated process.

According to the configuration of the first embodiment, captured images sequentially captured by the camera 32 are compressed by the H/W encoder 302 which achieves compression using a dedicated circuit, and are sequentially stored in the accumulation portion 303. Accordingly, the communication terminal 30 is capable of accumulating high-quality captured images using the H/W encoder 302. In addition, the captured images sequentially captured by the camera 32 and having a total number of pixels smaller than the total number of pixels employed by the H/W encoder 302 are compressed by the S/W encoder 306, and transmitted to the server device 2 using wireless communication. Accordingly, more reduction of communication costs is achievable than in a case of transmission of captured images compressed by the H/W encoder 302.

The S/W encoder 306 compresses the captured images on the general-purpose processor. This configuration can be more easily produced than a configuration which additionally includes the one more H/W encoder 302 for performing compression using a dedicated circuit. Furthermore, the configuration which uses both the H/W encoder 302 and the S/W encoder 306 can reduce shortage of processor resources. Accordingly, even while a general-purpose processor of a grade used in a built-in device is used, accumulation of captured images captured by the camera 32, and transmission of captured images captured by the camera 32 and compressed with conversion of the image scale of the captured images are both more easily achievable. As a result, reduction of communication costs during transmission of captured images is more easily achievable while accumulating high-quality captured images.

In addition, when the configuration which changes the region to be cut out by the conversion section 305 in accordance with the traveling state of the subject vehicle in each of the captured images captured by the camera 32 is adopted, a highly important region corresponding to the traveling state can be cut out. Accordingly, a captured image in the highly important region corresponding to the traveling state can be transmitted to the server device 2 while lowering the total number of pixels of the captured images captured by the camera 32.

### Second Embodiment

In the configuration presented in the first embodiment, the captured images compressed by the H/W encoder 302 and stored in the accumulation portion 303 are not transmitted to the server device 2. However, this configuration is not necessarily required to be adopted. For example, a configuration which transmits a part of the captured images stored in the accumulation portion 303 to the server device 2 in response to a request from the server device 2 may be adopted (hereinafter referred to as Embodiment 2).

(Schematic Configuration of Captured Image Transmission System 1a)

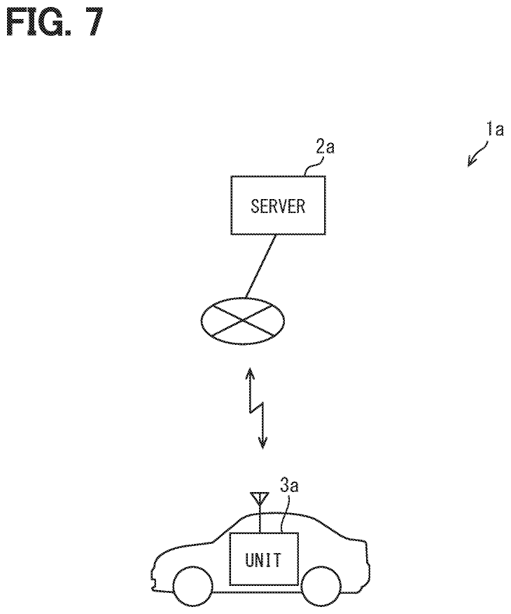

A configuration of the second embodiment will be hereinafter described. As shown in FIG. 7, a captured image transmission system 1a of the second embodiment includes a server device 2a, and a vehicle unit 3a provided on a vehicle. The vehicle unit 3a is similar to the vehicle unit 3 of the first embodiment except that a communication terminal 30a which performs processing partially different from the processing of the communication terminal 30 is provided in place of the communication terminal 30. Details of the communication terminal 30a will be described below. The server device 2a is similar to the server device 2 of the first embodiment except that the server device 2a requests the vehicle unit 3a to transmit a part of the captured images compressed by the H/W encoder 302 and stored in the accumulation portion 303.

The server device 2a receives captured images sequentially captured by the camera 32, transmitted from the communication terminal 30a after compression by the S/W encoder 306 of the communication terminal 30a, and having a smaller total number of pixels of each captured image than the total number of pixels employed by the H/W encoder 302 (hereafter referred to as simple image). Thereafter, when a captured image compressed by the H/W encoder 302 and stored in the accumulation portion 303 (hereinafter referred to as target image) in correspondence with the received simple image is necessary, a target image request requesting the target image is transmitted to the communication terminal 30a. For example, the target image request may include a time stamp of the requested target image.

The target image corresponding to the simple image may be a captured image acquired at the same imaging time as the imaging time of the simple image in the captured images compressed by the H/W encoder 302 and stored in the accumulation portion 303, or may be a captured image included in the captured images acquired at the imaging time within a fixed time range before and after the imaging time of the simple image. The imaging time of the captured image may be specified by a time stamp. Whether the target image is necessary may be determined by the server device 2a, or may be determined by an operator of the server device 2a. When whether the target image is necessary is determined by the server device 2a, the necessity of the target image may be determined when a predetermined event is detected from the simple image by an image recognition technology, for example.

(Schematic Configuration of Communication Terminal 30a)

A schematic configuration of the communication terminal 30a will be next described. As shown in FIG. 3, the communication terminal 30a includes the input portion 301, the H/W encoder 302, the accumulation portion 303, a microcomputer 304a, and a communication portion 307a. The communication terminal 30a is similar to the communication terminal 30 of the first embodiment except that the microcomputer 304a is provided instead of the microcomputer 304, and that a communication portion 307a is provided instead of the communication portion 307.

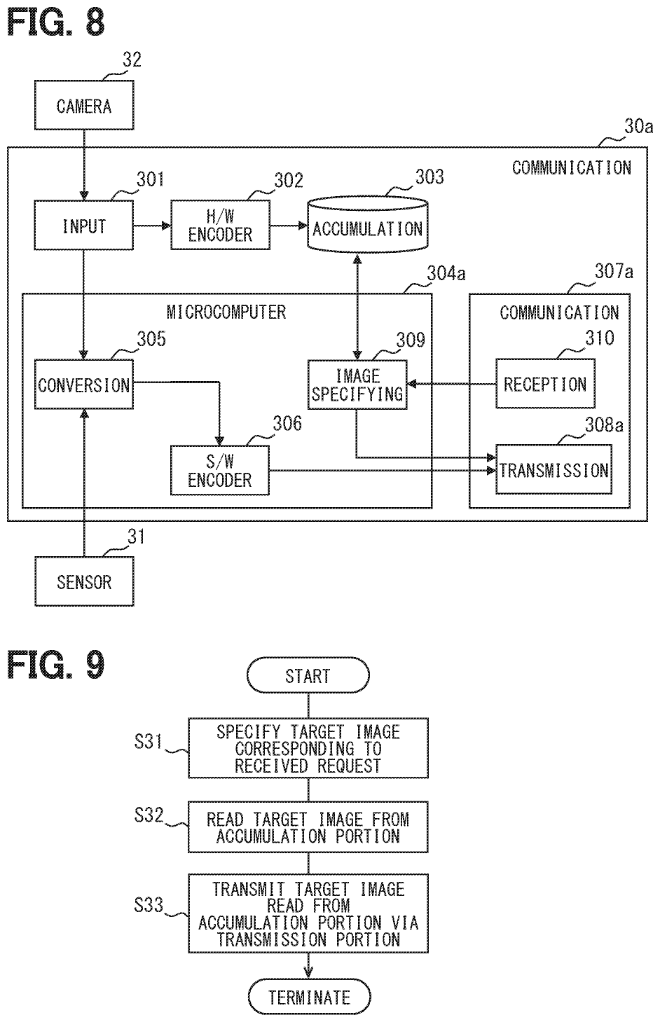

As shown in FIG. 8, the microcomputer 304a includes the conversion section 305, the S/W encoder 306, and a target image specifying section 309 as functional blocks. The microcomputer 304a is similar to the microcomputer 304 of the first embodiment except that the target image specifying section 309 is provided. As illustrated in FIG. 8, the communication portion 307a includes a transmission portion 308a and a reception portion 310. The communication portion 307a is similar to the communication portion 307 of the first embodiment except that a transmission portion 308a is provided instead of the transmission portion 308, and that the reception portion 310 is provided. Note that the communication portion 307 of the first embodiment may also include a reception portion.

The transmission portion 308a is similar to the transmission portion 308 of the first embodiment except that data to be transmitted is partially different. The transmission portion 308a transmits not only the above-described simple image compressed by the S/W encoder 306, but also the target image compressed by the H/W encoder 302 and stored in the accumulation portion 303 in response to reception of a target image request from the server device 2a. The reception portion 310 receives the target image request transmitted from the server device 2a.

When the target image request transmitted from the server device 2a is received by the reception portion 310, the target image specifying section 309 specifies the requested target image based on the target image request received by the reception portion 310. Thereafter, the requested target image is read from the accumulation portion 303. For example, the target image specifying section 309 may be configured to specify the requested target image based on a time stamp of the target image included in the target image request, and read the specified target image from the accumulation portion 303. The target image specifying section 309 transmits the target image read from the accumulation portion 303 to the transmission portion 308a, and allows the transmission portion 308a to transmit the target image to the server device 2a using wireless communication.

(Request Image Transmission Associated Process by Communication Terminal 30a)

An example of a flow of a process associated with transmission of a captured image (hereinafter referred to as request image transmission associated process) requested by the server device 2 and performed by the communication terminal 30a will be next described with reference to a flowchart of FIG. 9. The flowchart in FIG. 9 may be configured to start when a target image request transmitted from the server device 2a is received by the reception portion 310.

In S31, the target image specifying section 309 initially specifies a target image corresponding to a target image request received by the reception portion 310 based on the target image request. In S32, the target image specifying section 309 reads out the target image specified in S31 from the captured images compressed by the H/W encoder 302 and stored in the accumulation portion 303. In S33, the transmission portion 308a transmits the target image read in S32 to the server device 2a, and terminates the request image transmission associated process.

Effects similar to those of the first embodiment are produced also by the configuration of the second embodiment. Furthermore, according to the configuration of the first embodiment, the communication terminal 30a selects a target image corresponding to the request from the captured images compressed by the H/W encoder 302 and stored in the accumulation portion 303 in response to a request from the server device 2a, and transmits the target image corresponding to the request to the server device 2a. Accordingly, the server device 2a is capable of acquiring, as the captured image requested by the server device 2a, a high-quality captured image compressed by the H/W encoder 302 and stored in the accumulation portion 303 using wireless communication.

### Third Embodiment

In the first embodiment, the configuration which transmits a captured image compressed by the S/W encoder 306 to the server device 2a has been described. However, a configuration which includes multiple S/W encoders and selectively uses a different type of destination device to which a captured image is transmitted for each of the S/W encoders (hereinafter referred to as third embodiment) may be adopted.

(Schematic Configuration of Captured Image Transmission System 1b)

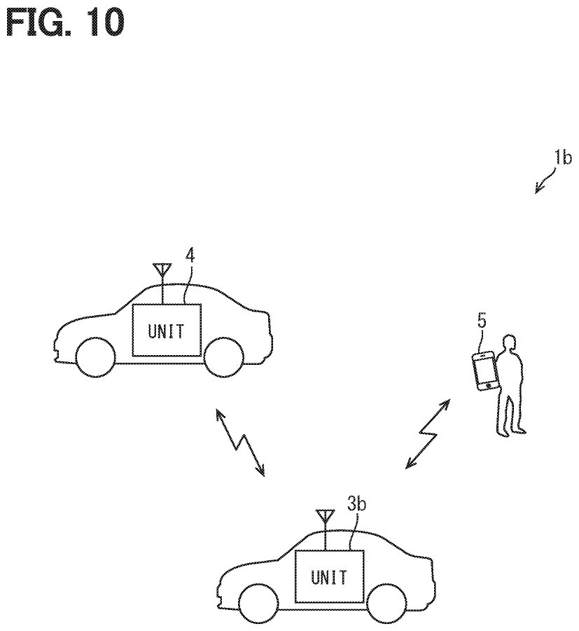

A configuration of the third embodiment will be hereinafter described. As shown in FIG. 10, a captured image transmission system 1 b according to the third embodiment includes a vehicle unit 3b and a vehicle unit 4 each provided on a vehicle, and a portable terminal 5 carried by a person. The vehicle unit 3b is similar to the vehicle unit 3 of the first embodiment except that a communication terminal 30b which performs processing partially different from the processing of the communication terminal 30 is provided in place of the communication terminal 30. Details of the communication terminal 30b will be described below.

The vehicle unit 4 provided on the vehicle includes a communication module and a display device, and receives a captured image compressed by the communication terminal 30b of the vehicle unit 3b and transmitted from the communication terminal 30b. The vehicle unit 4 may be configured to receive the compressed captured image transmitted from the vehicle unit 3b, and then perform decoding for expanding the compressed captured image to display the captured image. The vehicle unit 4 corresponds to the receiver device of the present disclosure.

The portable terminal 5 receives the captured image compressed by the communication terminal 30b of the vehicle unit 3b and transmitted from the communication terminal 30b. The portable terminal 5 may be configured to receive the compressed captured image transmitted from the vehicle unit 3b, and then perform decoding for expanding the compressed captured image to display the captured image. The portable terminal 5 may include a smart phone or the like, for example. The portable terminal 5 also corresponds to the receiver device of the present disclosure.

The vehicle unit 4 and the portable terminal 5 correspond to receiver devices of different types. According to the example described in the present embodiment, the vehicle unit 4 displays a captured image of quarter video graphics array (QVGA), and the portable terminal 5 displays a captured image of VGA.

(Schematic Configuration of Communication Terminal 30b)

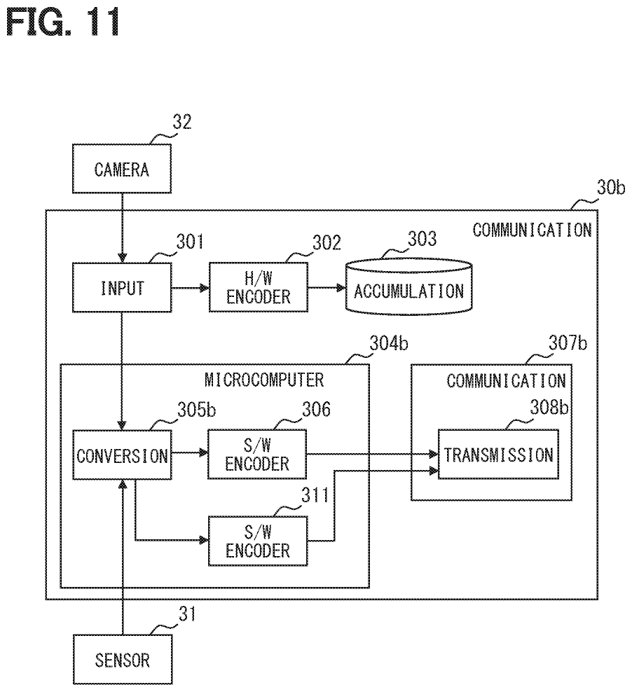

A schematic configuration of the communication terminal 30b will be next described. As shown in FIG. 11, the communication terminal 30b includes the input portion 301, the H/W encoder 302, the accumulation portion 303, a microcomputer 304b, and a communication portion 307b. The communication terminal 30b is similar to the communication terminal 30 of the first embodiment except that the microcomputer 304b is provided instead of the microcomputer 304, and that a communication portion 307b is provided instead of the communication portion 307.

As shown in FIG. 11, the microcomputer 304b includes a conversion section 305b, the S/W encoder 306, and an S/W encoder 311 as functional blocks. The microcomputer 304b is similar to the microcomputer 304 of the first embodiment except that the conversion section 305b is provided instead of the conversion section 305, and that the S/W encoder 311 is provided in addition to the S/W encoder 306. As shown in FIG. 11, the communication portion 307b includes a transmission portion 308b. The communication portion 307b is similar to the communication portion 307 of the first embodiment except that the communication portion 307b includes the transmission portion 308b instead of the transmission portion 308. Note that the communication portion 307b of the third embodiment may include a reception portion.

The conversion section 305b is similar to the conversion section 305 of the first embodiment except that conversion for lowering a total resolution of each of captured images sequentially acquired from the camera 32 via the input portion 301 is performed in accordance with each of the S/W encoder 306 and the S/W encoder 311. For example, a Full HD captured image with a resolution of 1920×1080 dots is converted into a VGA captured image with a resolution of 640×480 dots and transmitted to the S/W encoder 306, and also is converted into a QVGA captured image with a resolution of 320×240 dots and transmitted to the S/W encoder 311.

The S/W encoder 306 compresses the captured image after conversion of the image scale into the VGA captured image by the conversion section 305. On the other hand, the S/W encoder 311 compresses the captured image after conversion of the image scale into the QVGA captured image by the conversion section 305. More specifically, the S/W encoder 311 also compresses, on a general-purpose processor, the captured images sequentially captured by the camera 32 and each having a total number of pixels smaller than the total number of pixels used by the H/W encoder 302. It is assumed that the S/W encoder 306 and the S/W encoder 311 compress captured images having different total number of pixels.

The transmission portion 308b is similar to the transmission portion 308 of the first embodiment except that data to be transmitted is partially different. The transmission portion 308b transmits the VGA captured image compressed by the S/W encoder 306 to the portable terminal 5, and transmits the QVGA captured image compressed by the S/W encoder 311 to the vehicle unit 4.

Effects similar to those of the first embodiment are produced also by the configuration of the third embodiment. Furthermore, the configuration of the third embodiment is capable of compressing and transmitting captured images converted into images of different image scales in accordance with the types of destination device to which the captured images are transmitted.

### Fourth Embodiment

In the embodiments described above, the configuration which changes the region cut out by the conversion sections 305 and 305b in accordance with the traveling state of the subject vehicle is adopted. However, this configuration is not necessarily required to be adopted. For example, the region cut out by the conversion sections 305 and 305b may be fixed regardless of the traveling state of the subject vehicle. In this case, the communication terminals 30, 30a, and 30b may be configured not to acquire sensing information from the vehicle state sensor 31.

### Fifth Embodiment

While the communication terminals 30, 30a, and 30b are provided on the vehicle in the embodiments described above, this configuration is not necessarily required to be adopted. The communication terminals 30, 30a, and 30b can be provided on various moving bodies. In addition, the communication terminals 30, 30a, and 30b may be applied to a monitoring camera or the like fixed to an installation place. In this case, captured images sequentially acquired by the monitoring camera and compressed by the H/W encoder 302 may be stored in a non-volatile memory, and captured images compressed by the S/W encoder 306 and each having a smaller total number of pixels than a total number of pixels of each of captured images acquired by the monitoring camera may be transmitted to the server device 2 or the like using wireless communication.

It is noted that a flowchart or the processing of the flowchart in the present application includes multiple steps (also referred to as sections), each of which is represented, for instance, as S1. Further, each step can be divided into several sub-steps while several steps can be combined into a single step.

In the above, the embodiment, the configuration, an aspect of an image processing apparatus according to the present disclosure are exemplified. However, the present disclosure is not limited to every embodiment, every configuration and every aspect related to the present disclosure are exemplified. For example, embodiments, configurations, and aspects obtained from an appropriate combination of technical elements disclosed in different embodiments, configurations, and aspects are also included within the scope of the embodiments, configurations, and aspects of the present disclosure.

What is claimed is:

1. An image processing apparatus comprising:
a hardware encoder that is configured to compress captured images with a dedicated circuit, the captured images being sequentially captured by an imaging device;
a plurality of software encoders that is configured to compress the captured images on a general-purpose processor, wherein each of the software encoders compresses the captured images having different total number of pixels and each having a smaller total number of pixels than a total number of pixels employed by the hardware encoder;
a non-volatile memory that is configured to sequentially store the captured images compressed by the hardware encoder; and
a transmission portion that transmits, through wireless communication, the captured images compressed by the software encoders to a receiver device that is an external device of the image processing apparatus,
wherein:
the transmission portion selectively employs a type of the receiver device to which the compressed captured image is transmitted for each of the plurality of software encoders.

2. The image processing apparatus according to claim 1, wherein:
the image processing apparatus is provided on a vehicle;
at least one of the software encoders compresses a captured image in a partial region of each of the captured images sequentially captured by the imaging device; and
a region compressed by the at least one of the software encoders in each of the captured images sequentially captured by the imaging device is changed in accordance with a traveling state of the vehicle.

3. The image processing apparatus according to claim 2, wherein:
an imaging range of the imaging device includes at least a front of the vehicle; and
the region compressed by the at least one of the software encoders is a partial region in the front of the vehicle in each of the captured images sequentially captured by the imaging device during traveling of the vehicle, and includes an area where a moving object is located in each of the captured images sequentially captured by the imaging device during a stop of the vehicle.

4. The image processing apparatus according to claim 1, further comprising:
a reception portion that receives a target image request transmitted from the receiver device to which the captured image compressed by a software encoder of the software encoders has been transmitted, the target image request requesting a target image as a captured image compressed by the hardware encoder and corresponding to the captured image compressed by the corresponding software encoder,
wherein:
the transmission portion transmits the target image accumulated in the non-volatile memory to the receiver device that is a transmission source of the target image request in response to that the reception portion receives the target image request.

5. An image processing apparatus comprising:
a hardware encoder that is configured to compress captured images with a dedicated circuit, the captured images being sequentially captured by the imaging device;
a software encoder that is configured to compress the captured images on a general-purpose processor to have a smaller total number of pixels than a total number of pixels employed by the hardware encoder;
a non-volatile memory that is configured to sequentially store the captured images compressed by the hardware encoder; and
a transmission portion that transmits, through wireless communication, the captured images compressed by the software encoder to a receiver device that is an external device of the image processing apparatus,
wherein:
the image processing apparatus is provided on a vehicle;
the software encoder compresses a captured image in a partial region of each of the captured images sequentially captured by the imaging device;
a region compressed by the software encoder in each of the captured images sequentially captured by the imaging device is changed in accordance with a traveling state of the vehicle;
an imaging range of the imaging device includes at least a front of the vehicle; and
the region compressed by the software encoder is a partial region in the front of the vehicle in each of the captured images sequentially captured by the imaging device during traveling of the vehicle, and includes an area where a moving object is located in each of the captured images sequentially captured by the imaging device during a stop of the vehicle.

6. The image processing apparatus according to claim 5, further comprising:
a reception portion that receives a target image request transmitted from the receiver device to which the captured image compressed by the software encoder has been transmitted, the target image request requesting a target image as a captured image compressed by the hardware encoder and corresponding to the captured image compressed by the software encoder,
wherein:
the transmission portion transmits the target image accumulated in the non-volatile memory to the receiver device that is a transmission source of the target image request in response to that the reception portion receives the target image request.

7. An image processing apparatus comprising:
a hardware encoder that is configured to compress a captured image captured by an imaging device with a dedicated circuit;
a non-volatile memory that is configured to store a compressed image compressed by the hardware encoder;
a general-purpose processor that includes
a first software encoder that is configured to compress the captured image to generate a first compressed image;
a second software encoder that is configured to compress the captured image to generate a second compressed image, wherein total number of pixel of the first compressed image is different from total number of pixel of the second compressed image, and each of the total numbers of pixels of the first compressed image and the second compressed image is smaller than a total number of pixels of the compressed image by the hardware encoder; and
a transmission portion that transmits, through wireless communication, the first compressed image and the second compressed image to at least two receiver devices outside the image processing apparatus,
wherein:
the transmission portion selects a receiver device of the receiver devices to which each of the compressed images is transmitted for each of the software encoders.
